(19) United States
(12) Patent Application Publication
(10) Pub. No.: US 2007/0011416 A1
(43) Pub. Date: Jan. 11, 2007

(54) Data storage device and medium and related method of storing backup data

(76) Inventor: Sung-Woo Lee, Yongin-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/330,993

(22) Filed: Jan. 13, 2006

(30) Foreign Application Priority Data
Jul. 8, 2005 (KR) 10-2005-0061897

(51) Int. Cl. G06F 12/16

(52) U.S. Cl. 711/162

(57) ABSTRACT

Provided are an apparatus, related method of storing data, and a computer readable recording medium. The apparatus includes a source/destination memory, a non-volatile back-up memory, and a transaction management module. The transaction management module is adapted to erase a plurality of memory location in backup memory upon initialization of the apparatus or following a primary data transaction.

### BACKGROUND OF THE INVENTION

1. Field of the Invention

Embodiments of the invention relate to an apparatus and method for storing data. More particularly, embodiments of the invention relate to a data storage apparatus and method capable of reducing the time required to store (or back up) data in a non-volatile memory.

This application claims the benefit of Korean Patent Application No. 10-2005-0061897, filed on Jul. 8, 2005, the subject matter of which is hereby incorporated by reference.

2. Description of the Related Art

Electrically erasable programmable read-only memory (EEPROM) is used quite commonly as a non-volatile memory component in a data storage device. For example, EEPROM is commonly used in portable data systems such as smart cards.

Using a conventional smart card application as an illustrative example, most data transactions on a smart card typically require updating data stored in non-volatile memory, (e.g., the EEPROM) on a unit block by unit block basis (e.g., in units of 64 bytes or 128 bytes of data). In this description, the term “update” is used to generally indicate an initial data “update operation” and/or a subsequent data “backup operation.” Both of these update operations usually involve the erasing and writing of data.

Most smart card data transactions involve one or more update operation(s) and/or one or more backup operation(s). Conventionally, update operations are directed to data stored in a designated “source area” of memory, while data backup operations are directed to data stored in a designated “transaction area” (or a “backup area”) of memory. Either the source area or the backup area may be used as a destination for data being stored and/or updated.

Whenever backup operation or an update operation is performed, data previously stored in the destination area (whether a backup area of memory or both a source and backup area of memory) must typically be erased using an erase operation. Thereafter, new data is written to the destination area using a data write operation.

Thus, if one assumes a single transaction comprising N backup operations and N update operations, at least N data erase operations and N data write operations must be performed to execute the single transaction. This duplicative quantity of operations takes a great deal of time to execute, but is nonetheless required to implement conventional data backup safeguards.

### SUMMARY OF THE INVENTION

Embodiments of the invention provide a data storage apparatus, and a related method of operation, which reduce the amount of time required to implement data backup safeguards in mobile data storage system, such as a smart card. Embodiments of the invention also provide a computer readable recording medium and related method of operation directed to the same purpose.

In one embodiment, the invention provides a method of performing a data backup operation storing data in a plurality of memory locations in a non-volatile memory in relation to a primary data transaction, the method comprising; simultaneously erasing the plurality of memory locations, and thereafter writing data to the plurality of memory locations. In one related aspect, the non-volatile memory comprises a backup memory area associated with the plurality of memory locations, and the step of simultaneously erasing the plurality of memory locations comprises simultaneously erasing all of the plurality of memory locations in the backup memory area in a single erase operation. In another related aspect, the non-volatile memory comprises a backup memory area comprising multiple memory pages associated with the plurality of memory locations, and the step of simultaneously erasing the plurality of memory locations comprises erasing the plurality of memory locations on a page by page basis in a single erase operation.

In another embodiment, the invention provides a method of performing a data backup operation in a data storage device, comprising a memory, the memory comprising a source/destination memory area and a non-volatile backup memory area, wherein the data backup operation is adapted to store data in a plurality of memory locations in the non-volatile backup memory area, the method comprising; in response to either initializing the data storage device or completing a primary data transaction, simultaneously erasing the plurality of memory locations and thereafter writing data from the source/destination memory area to the plurality of memory locations.

In yet another embodiment, the invention provides a computer storage device readable by machine, tangibly embodying a program of instruction executable by the machine to perform a backup operation adapted to store data in a plurality of memory locations in the non-volatile backup memory area, the program comprising; simultaneously erasing the plurality of memory locations, and thereafter writing data to the plurality of memory locations.

In still another embodiment, the invention provides a data storage apparatus comprising a memory, the memory comprising a source/destination memory area and a non-volatile backup memory area, and a transaction management module executable by the data storage apparatus and adapted to determine whether the data storage apparatus is initialized and whether a primary data transaction is terminated, and further adapted to simultaneously erase a plurality of memory locations in the non-volatile backup memory area in response thereto, and thereafter write data to the plurality of memory locations.

### BRIEF DESCRIPTION OF THE DRAWINGS

Several embodiments of the invention will be described with reference to the accompanying drawings in which:

FIG. 1 is a concept view describing a conventional data update operation and a data backup operation;

FIG. 2 is a block diagram of a smart card comprising a transaction management module according to an embodiment of the present invention;

FIGS. 3A and 3B are concept views describing a data update operation and a data backup operation according to en embodiment of the present invention; and

FIG. 4 is a flowchart illustrating a method of storing data according to an embodiment of the present invention.

### DETAILED DESCRIPTION OF THE INVENTION

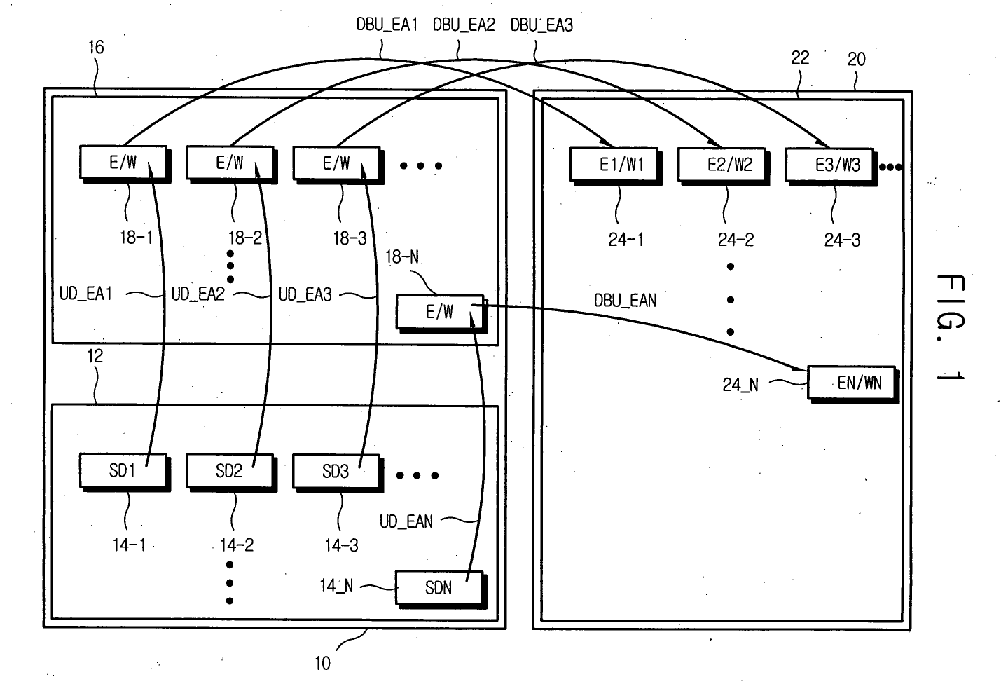

FIG. 1 is a concept diagram describing a conventional data update operation and a data backup operation. Referring to FIG. 1, in response to data transaction (e.g., an applet such as a Java Applet) comprising multiple data update operations UD_EA1, UD_EA2, UD_EA3, . . . , UD_EAN (where “N” is a natural number), data is stored in respective memory locations 18_1, 18_2, 18_3, . . . , 18_N of a destination area 16 within a source/destination memory 10 with source data SD1, SD2, SD3, . . . , SDN previously stored in corresponding memory locations 14_1, 14_2, 14_3, . . . , 14_N of a source area 12.

In other words, the respective memory locations 18_1, 18_2, 18_3, . . . , 18_N in destination area 16 are updated with source data SD1, SD2, SD3, . . . , SDN by sequentially performed erase operations (E) and write operations (W). In the illustrated example, source area 12 may be formed by a RAM, a ROM, or an EEPROM, and destination area 16, as well as backup area 22, may be formed by one or more non-volatile memories.

In a first data backup operation DBU_EA1, data stored in a first backup memory location 24_1 is erased (E1) and then data stored in a first destination memory location 18_1 is backed up using a write operation (W1) to this same memory location. This process continues memory location by memory location, until in a final data backup operation DBU_EAN, data stored in a final backup memory location 24_N is erased (EN) and data from a last destination memory location 18_N is backed up (WN) into the final backup memory location 24_N.

Thus, if we assume that each erase operation (E) and each backup write operation requires a time “T” to execute, the total time associated with the exemplary data transaction is 2T×N.

If we further assume the conventional use of a transaction flag in conjunction with the exemplary data transaction, the foregoing data backup process may be described according to Table 1.

That is, when the transaction flag indicates that the data transaction is being performed (e.g., the transaction flag is set to ON), a data erase operation (requiring execution time “T”) is executed to erase the data previously stored in the non-volatile memory forming backup memory area 22. Thereafter, data backup write operation (requiring execution time “T”) is executed to write new data to a memory location in the non-volatile memory from which the data was just erased. Accordingly, the total time during which the transaction flag is set to ON is 2T for a single data backup cycle.

Likewise, when the transaction flag indicates that a data transaction is terminated (e.g., the transaction flag is set to OFF), the data erase operation and the data backup write operation are also required, and thus, a total time required to set the transaction flag to OFF is also 2T under the foregoing assumptions. Accordingly, when a conventional data backup operation comprising “N” cycles (e.g., N memory locations are backed up) is performed in a backup memory area 22 of non-volatile memory 20, a total time required for the data backup is 4T+N(2T)=2T(2+N).

TABLE 1

| | Number of Data Backup | |
|---|---|---|
| Execution Process | (Operations) | Total Time |
| Transaction Flag ON | 1 (Erase + Write) | 2T |
| Data Backup | N (Erase + Write) | N × (2T) |
| Transaction Flag OFF | 1 (Erase + Write) | 2T |
| Total Required Time | 4T + N(2T) = 2T × (2 + N) | |

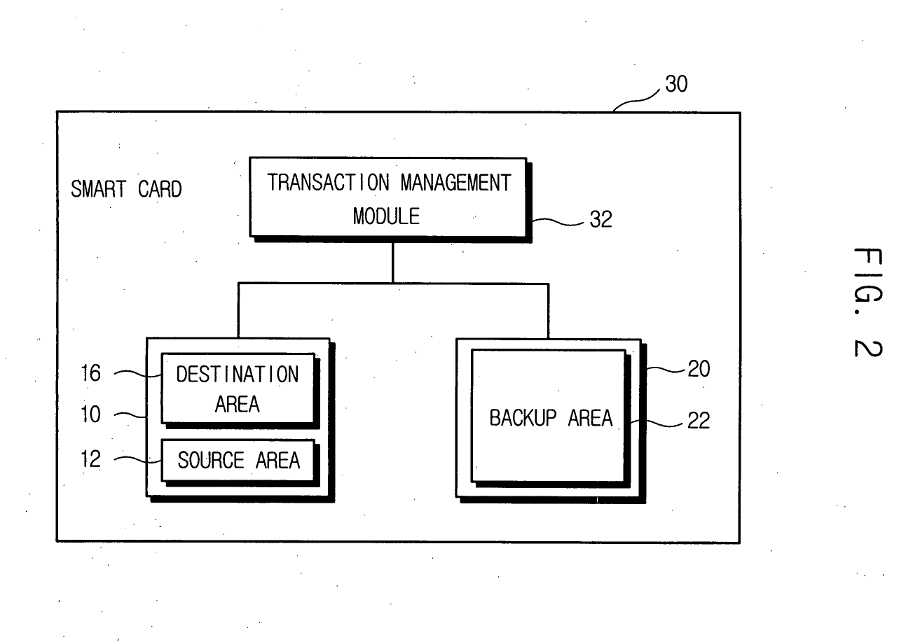

FIG. 2 is a block diagram of an exemplary data storage device (e.g., a smart card) 30 comprising a transaction management module designed in accordance with an embodiment of the invention. Referring to FIG. 2, smart card 30 comprises a source/destination memory 10 adapted to store source data; a non-volatile memory 20 comprising a backup area 22; and a transaction management module 32. The transaction management module 32 may be implemented in one of many conventionally understood forms. For example, transaction management module 32 may be implemented as a stand-alone control module (e.g., a software routine run on the smart card processor) or as part of an integrated operating system (OS) associated with the smart card processor. However implemented, transaction management module 32 may be adapted to determine (1) whether the smart card system has been initialized; and (2) whether a primary data transaction (or, atomicity transaction) is ongoing or is terminated. Transaction management module 32 may be further adapted to control a data backup transaction (e.g., a subordinated data transaction relative to the primary data transaction) during which data previously stored in backup memory area 22 of non-volatile memory 20 is erased, at a time, and thereafter source data otherwise stored in memory 10 is written to the backup memory area 22. In one embodiment, this data backup transaction is performed only when smart card 30 is initialized and the primary data transaction is terminated.

Although not shown in FIG. 2, smart card 30 further comprises a conventional processor (e.g., a computational logic circuit). The processor may be used to implement a Java virtual machine adapted to execute a Java Applet. In this more specific exemplary embodiment, smart card 30 may also comprise a native interface adapted to connect a card Applet (e.g. Java Applet) with a smart card operating system associated with the processor. Transaction management module 32 runs on the processor in association with the smart card operating system and executes the foregoing data backup transaction. That is, the transaction management module 32 may be adapted to manage the use of source/destination memory 10 and/or non-volatile memory 20, as well as one or more device drivers adapted to exchange data via hardware data paths provided by smart card 30; utility and device drivers adapted to store available utilities; and an encryption and/or decryption module(s) adapted to manage encryption and decryption operations.

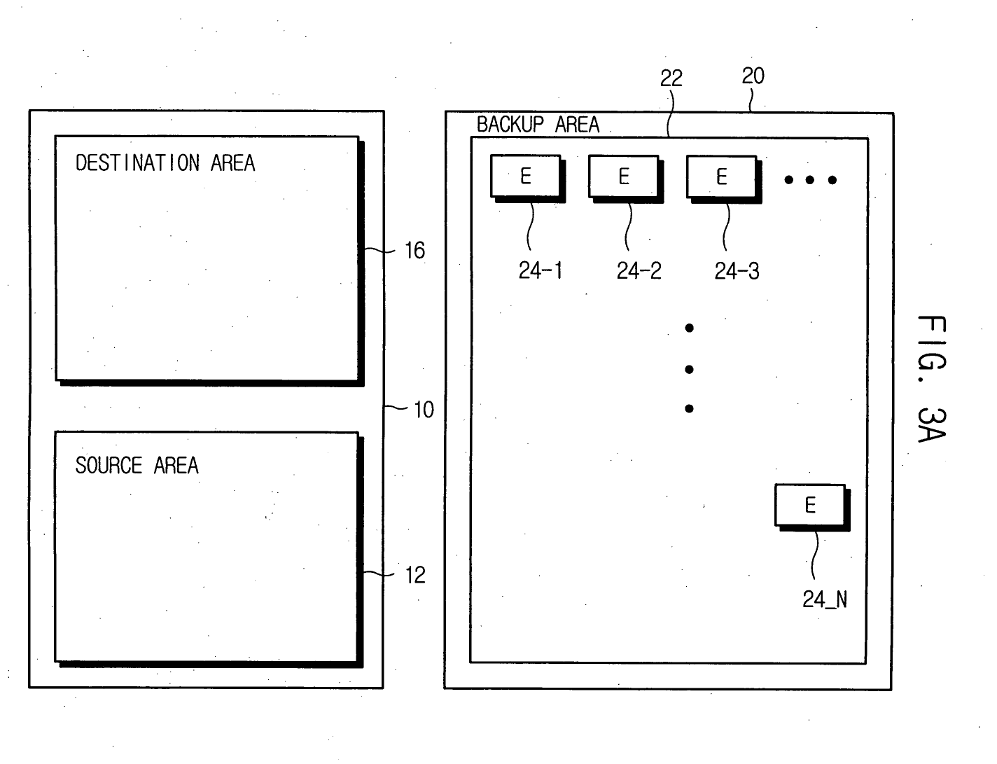

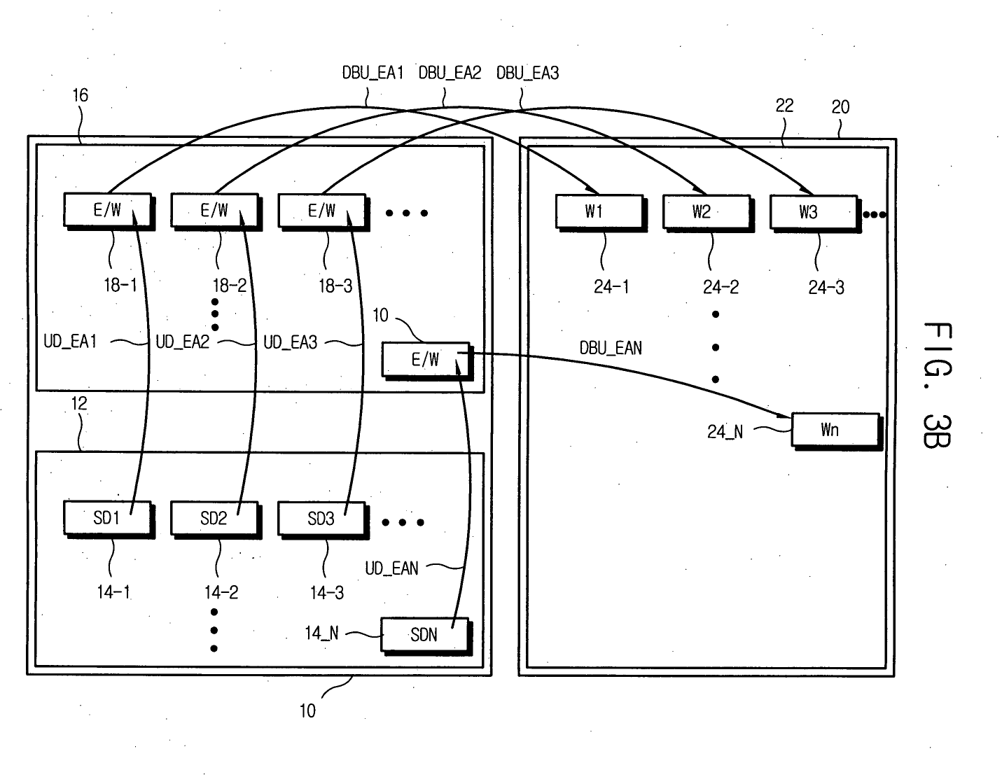

FIGS. 3A and 3B are concept diagrams describing a data update operation and a data backup operation according to an embodiment of the present invention. Referring to FIG. 3A, all data stored in respective memory locations 24_1, 24_2, 24_3, . . . , 24_N of backup area 22 are “simultaneously erased.” The term “simultaneously erased” is used to describe any process by which all of a plurality of memory locations in backup memory 22 are substantially erased during a unitary period of time (e.g., a single uninterrupted erase process). Within this context, if the time previously required to erase the data stored a single one of memory locations 24_1, 24_2, 24_3, . . . , 24_N is “T”, the time required by the illustrated embodiment of the invention to simultaneously erase all of the memory locations in backup memory area 22, as implicated in a primary data transaction, is also substantially equal to “T” Also, according to another embodiment of the present invention, if the backup area 22 comprises a plurality of data pages, the data stored in the backup memory area 22 may be erased on a page unit by page unit basis, (e.g., for N pages, where N is a natural number).

Under the foregoing assumptions wherein a conventional transaction flag is used, the data stored in relation to the transaction flag (e.g., data used to indicate the state of the transaction flag) as well as data stored in relation to the execution state of the primary data transaction, where present, (e.g., data used to indicate whether transaction is ongoing or terminated) may also be simultaneously erased or updated in conjunction with the data backup transaction.

Referring to FIG. 3B, since all data stored in the respective memory locations 24_1, 24_2, 24_3, . . . , 24_N of backup memory 22 have been erased, and assuming that the time required to write new data to each of these memory locations is “T,” the total time required to write new data to memory locations in backup memory 22 is (N×T).

Table 2 further illustrates this example. That is, Table 2 shows the number of times and the resulting execution time required to perform the data backup transaction assuming an Applet requiring “N” memory location write operations, and further assuming that all of the memory locations in backup area 22 of a non-volatile memory 20 are arranged in page units (e.g., PR#1, PR#2). Here, B_EPS represents the number of pages to which data are actually backed up in backup area 22. Clearly, the following numbers may be varied with memory system design.

TABLE 2

| | | Number of Data | |
|---|---|---|---|
| | Execution Process | Backup (Operations) | Total Time |
| PR#1 (Erasing | Transaction Flag | 1( Write Only) | T |
| Backup Area in | “ON” | | |
| Units of pages) | Data Backup | N (Write Only) | N × T |
| | Transaction Flag | B_EPS (Write | B_EPS × T |
| | “OFF” | Only) | |
| | Total Time | T(1 + N + B_EPS) | |
| PR#2 | Transaction Flag | 1 (Write Only) | T |
| (Simultaneously | “ON” | | |
| Erasing Entire | Data Backup | N ( Write Only) | NT |
| Backup Area) | Transaction Flag | 1 (Write Only) | T |
| | “OFF” | | |
| | Total Time | T (2 + N) | |

Assuming that an execution time of “T” for each erase and write operation T, B_EPS is 5 pages, and data backup is performed “N” times in relation to a primary data transaction, Table 3 compares a total time required for conventional data backup transaction with a total time required for data backup transaction according to one embodiment of the present invention.

TABLE 3

| | | Variable | | | |
|---|---|---|---|---|---|
| | | T | | | |
| | | 2 ms | | | |
| | | B_EPS | | | |
| | | 5 pages | | | |
| | | N | | | |
| Technique | | 4 | 10 | 20 | 30 |
| Conventional | 2T(2 + N) | 24 | 48 | 88 | 128 |
| Technique | | | | | |
| PR#1 | T(1 + N + B_EPS) | 20 | 32(48/32 = 1.5) | 52(1.7) | 72(1.8) |
| | | (24/20 = 1.2) | | | |
| PR#2 | T(2 + N) | 12(24/12 = 2) | 24(48/24 = 2) | 44(2) | 64(2) |

Assuming that an execution time of “T” for each erase and write operation T, B_EPS is 10 pages, and data backup is performed “N” times in relation to a primary data transaction, Table 4 compares a total time required for conventional data backup transaction with a total time required for data backup transaction according to one embodiment of the present invention.

TABLE 4

| | | Variable | | | |
|---|---|---|---|---|---|
| | | T | | | |
| | | 2 ms | | | |
| | | B_EPS | | | |
| | | 10 pages | | | |
| | | N | | | |
| Technique | | 4 | 10 | 20 | 30 |
| Conventional | 2T(2 + N) | 24 | 48 | 88 | 128 |
| Technique | | | | | |
| PR#1 | T(1 + N + B_EPS) | 30(24/30 = 0.8) | 42(48/42 = 1.1) | 62(1.4) | 82(1.6) |
| PR#2 | T(2 + N) | 12(24/12 = 2) | 24(48/24 = 2) | 44(2) | 64(2) |

Referring to Table 4, if N=4 and B_EPS=10, a total time (30) for PR#1 is longer than a total time 24 for the conventional technique. In general, if B_EPS is greater than N+3, a total time 30 for PR#1 is longer than a total time (24) for the conventional technique. Such a case where a total time required according to the present invention exceeds a total time required according to the conventional technique, occurs when B_EPS is large, N is small, and the size of data to be, backed up is large.

For example, if N=4 and B_EPS=10, the length x of each backup data satisfies the equation below. Here, each EEPROM page is 128 bytes long.
4(4+2+x)=128×10

In this case, the length x of each backup data is 320, which is rarely if ever obtained in a smart card. This result arises from the fact that the length of backup data available in a general smart card application is several dozens of bytes, and more particularly, several hundreds of bytes or more for a conventional certificate. That is, since the backup data is usually backed up in application protocol data units (APDUs), the case where a total time for PR#1 exceeds that for the conventional technique would be very rare indeed.

During a transaction, as the number of times that a data backup operation to be performed increases, a total time for PR#1 is half the total time associated with the conventional technique. If memory space is limited and B_EPS is smaller than a predetermined positive integer, the ratio between a total time for PR#1 and that associated with the conventional technique may be given as:

$${lim}_{N -> ∞} \frac{2 T ( 2 + N )}{T ( 1 + N + B\_EPS )} = 2$$

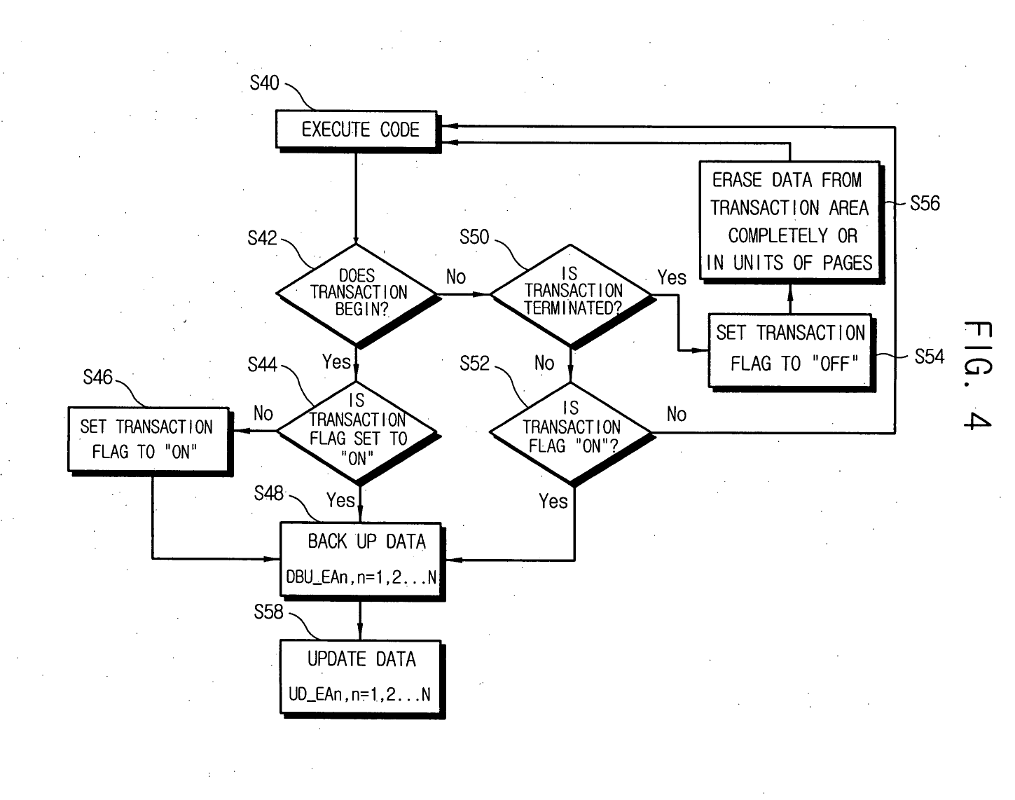

FIG. 4 is a flowchart further illustrating a method of storing data according to an embodiment of the present invention. A method of storing (or backing up) data in a non-volatile memory will now be described in some additional detail with reference to FIG. 2 through 4. Exemplary method steps are indicated by (SXX).

Transaction management module 32 begins executing code (S40) and determines whether a primary transaction is started (S42). If it is determined that the primary transaction is started, transaction management module 32 determines whether a transaction flag is set to ON (S44). Transaction management module 32 sets the transaction flag to ON when the transaction flag is not so set (S46).

However, if it is determined that the primary transaction is not started, transaction management module 32 determines whether the primary transaction is terminated (S50). If it is determined that the primary transaction is terminated, transaction management module 32 sets the transaction flag to OFF (S54), and, simultaneously erases data stored in backup memory area 22 either all at once or all at once on a page by page basis, depending on the structure and organization of non-volatile memory 20 (S56). Then, transaction management module 32 executes the code (S40).

In one embodiment, the time required to erase all implicated memory locations in backup memory 22 is preferably equal to the time required to a single memory location in the backup memory 22.

If the transaction flag is set to ON, transaction management module 32 writes data stored in the respective memory locations 18_1, 18_2, 18_3, . . . , 18_N of destination area 16 to their corresponding memory locations 24_1, 24_2, 24_3, . . . , 24_N in backup memory 22 (S48). That is, the data backup operations DBU_EA1, DBU_EA2, DBU_EA3, . . . , DBU_EAN (where N is an integer) are performed.

The data stored in the respective memory locations 18_1, 18_2, 18_3, . . . , 18_N in destination area 16 are updated with data from respective memory locations 14_1, 14_2, 14_3, . . . , 14_N in source area 12 (S58). In the illustrated example, the erase and write operations are sequentially performed.

The foregoing methods embodiments of the invention may be implemented and executed in a conventional program form adapted for used with a computer or digital logic system. Enabling programs may be stored in and read from computer readable recording medium, and executed by a processor or other computational logic. Examples of the computer readable recording medium adapted to store such programs include, as example, magnetic storage media (ROMs, floppy disks, hard disks, etc.), optical reading media (CD-ROMs, DVDs, etc.), and carrier waves (e.g., as transmitted through the Internet).

However implemented or stored, a method of storing data in a non-volatile memory or computer readable recording medium in accordance with an embodiment of the present invention, allows significantly reduced data transaction time, particularly as it relates to data backup operations.

While the present invention has been particularly shown and described with reference to exemplary embodiments thereof, it will be understood by those of ordinary skill in the art that various changes in form and details may be made therein without departing from the scope of the present invention as defined by the following claims.

What is claimed is:

1. A method of performing a data backup operation storing data in a plurality of memory locations in a non-volatile memory in relation to a primary data transaction, the method comprising:
simultaneously erasing the plurality of memory locations; and thereafter,
writing data to the plurality of memory locations.

2. The method of claim 1, wherein the non-volatile memory comprises a backup memory area associated with the plurality of memory locations, and wherein simultaneously erasing the plurality of memory locations comprises simultaneously erasing all of the plurality of memory locations in the backup memory area in a single erase operation.

3. The method of claim 1, wherein the non-volatile memory comprises a backup memory area comprising multiple memory pages associated with the plurality of memory locations, and wherein simultaneously erasing the plurality of memory locations comprises erasing the plurality of memory locations on a page by page basis in a single erase operation.

4. The method of claim 1, further comprising:
setting a transaction flag to ON upon initiation of the primary data transaction; and
storing data in a source/destination memory in relation to the primary data transaction.

5. The method of claim 4, further comprising:
completing the primary transaction and setting the transaction flag to OFF prior to simultaneously erasing the plurality of memory locations.

6. The method of claim 5, wherein storing data in the source/destination memory comprises storing transferring the data from a source memory area to a destination memory area.

7. The method of claim 6, wherein the source memory area comprises a Random Access Memory (RAM) and the destination memory area comprises a non-volatile memory.

8. A method of performing a data backup operation in a data storage device, comprising a memory, the memory comprising a source/destination memory area and a non-volatile backup memory area, wherein the data backup operation is adapted to store data in a plurality of memory locations in the non-volatile backup memory area, the method comprising:
in response to either initializing the data storage device or completing a primary data transaction, simultaneously erasing the plurality of memory locations; and thereafter writing data from the source/destination memory area to the plurality of memory locations.

9. The method of claim 8, wherein simultaneously erasing the plurality of memory locations comprises simultaneously erasing all of the plurality of memory locations in the backup memory area in a single erase operation.

10. The method of claim 8, wherein the backup memory area comprises multiple memory pages, and wherein simultaneously erasing the plurality of memory locations comprises erasing the plurality of memory locations on a page by page basis in a single erase operation.

11. The method of claim 8, further comprising:
setting a transaction flag to ON upon initiation of the primary data transaction; and
storing data in the source/destination memory in relation to the primary data transaction.

12. The method of claim 11, further comprising:
completing the primary transaction and setting the transaction flag to OFF prior to simultaneously erasing the plurality of memory locations.

13. The method of claim 12, wherein storing data in the source/destination memory comprises storing transferring the data from a source memory area to a destination memory area.

14. A computer storage device readable by machine, tangibly embodying a program of instruction executable by the machine to perform a backup operation adapted to store data in a plurality of memory locations in the non-volatile backup memory area, the program comprising:
simultaneously erasing the plurality of memory locations; and thereafter,
writing data to the plurality of memory locations.

15. The computer storage device readable of claim 14, wherein the non-volatile memory comprises a backup memory area associated with the plurality of memory locations, and wherein simultaneously erasing the plurality of memory locations comprises either simultaneously erasing all of the plurality of memory locations in the backup memory area in a single erase operation, or erasing the plurality of memory locations on a page by page basis in a single erase operation.

16. A data storage apparatus comprising a memory:
wherein the memory comprises a source/destination memory area and a non-volatile backup memory area; and
a transaction management module executable by the data storage apparatus and adapted to determine whether the data storage apparatus is initialized and whether a primary data transaction is terminated, and further adapted to simultaneously erase a plurality of memory locations in the non-volatile backup memory area in response thereto, and thereafter write data to the plurality of memory locations.

17. The data storage apparatus of claim 16, wherein the transaction management module erases data the plurality of memory location in the non-volatile backup area on a page by page basis in a single erase operation.
